(19) United States
(12) Patent Application Publication
(10) Pub. No.: US 2025/0038440 A1
(43) Pub. Date: Jan. 30, 2025

(54) ELECTRICAL CONNECTOR FOR CIRCUIT BOARDS

(71) Applicant: Hirose Electric Co., Ltd., Yokohama (JP)

(72) Inventors: Yoshitaka HAYAKAWA, Yokohama (JP); Kentaro DOI, Yokohama (JP)

(21) Appl. No.: 18/786,127

(22) Filed: Jul. 26, 2024

(30) Foreign Application Priority Data
Jul. 28, 2023 (JP) 2023-123123

(51) Int. Cl. H01R 12/71; H01R 12/91

(52) U.S. Cl. CPC H01R 12/716; H01R 12/91

(57) ABSTRACT

To provide an electrical connector for circuit boards capable of implementing a good impedance match while permitting relative movement of the movable housing with respect to the stationary housing. The intermediate portions 15 of the terminals 10 are, at least in part, located in the interior space 25 of the electrical connector for circuit boards 1, the electrical connector for circuit boards 1 has contoured portions 23 made of dielectric material which, relative to the intermediate portions 15, are positioned on the side opposite the interior space 25 and extend along the intermediate portions 15 while being spaced by a clearance from the intermediate portions 15, and the contoured portions 23 are capable of following the intermediate portions 15 when the intermediate portions 15 are resiliently deformed in the connector width direction perpendicular to the terminal array direction.

### BACKGROUND

### Cross-Reference to Related Applications

This application claims priority to Japanese Patent Application No. 2023-123123, filed Jul. 28, 2023, the contents of which are incorporated herein by reference in its entirety for all purposes.

### TECHNICAL FIELD

The present invention relates to an electrical connector for circuit boards disposed on a mounting face of a circuit board.

### RELATED ART

Known electrical connectors for circuit boards of this type include, for example, the electrical connector of Patent Document 1. In the electrical connector of Patent Document 1, multiple terminals, which are arranged such that the terminal array direction is a direction parallel to a mounting face of a circuit board, are provided spanning between a stationary housing and a movable housing, which are separate pieces (separate members). The stationary housing is secured to the circuit board through the medium of the terminals. The movable housing is adapted to be capable of relative movement with respect to the stationary housing due to resilient deformation of the terminals.

The terminals, which are made by bending metal strip-like pieces in the through-thickness direction, are adapted to be solder connectable to the mounting face of the circuit board with the help of connecting portions formed at the bottom ends thereof while being adapted to be capable of contacting counterpart terminals provided in a counterpart connector with the help of contact portions formed at the top ends thereof. In addition, stationary-side retained portions retained in the stationary housing, movable-side retained portions retained in the movable housing, and deformation portions coupling the stationary-side retained portions and the movable-side retained portions are provided between the connecting portions and the contact portions.

The deformation portions, which extend between the two housings without being retained in the stationary housing or in the movable housing, permit movement of the movable housing due to resilient deformation of said deformation portions. The deformation portions are covered by impedance matching portions made of dielectric material. The impedance matching portions are formed by integral molding with the deformation portions in contact with the outer surface of said deformation portions and are adapted to be resiliently deformable along with said deformation portions. In Patent Document 1, covering the deformation portions with the impedance matching portions in this manner adjusts the impedance of the terminals and, as a result, achieves an impedance match.

### PATENT DOCUMENTS

### Patent Document 1

Japanese Patent Application Publication No. 2014-222576.

### SUMMARY

### Problems to be Solved

In Patent Document 1, the impedance matching portions are formed in contact with the deformation portions of the terminals. When the impedance matching portions made of dielectric material are placed in contact with the deformation portions in this manner, there is a risk that the impedance of said deformation portions will drop too low and an impedance match in the terminals will be difficult to achieve.

With such circumstances in mind, it is an object of the present invention to provide an electrical connector for circuit boards capable of implementing a good impedance match while permitting relative movement of the movable housing with respect to the stationary housing.

### Technical Solution

(1) The inventive electrical connector for circuit boards is an electrical connector for circuit boards disposed on a mounting face of a circuit board, said connector having a plurality of terminals arranged such that the terminal array direction is a direction parallel to the mounting face, a stationary housing secured to the circuit board through the medium of the terminals, and a movable housing capable of relative movement with respect to the stationary housing, wherein the terminals have a stationary-side retained portion retained in the stationary housing, a movable-side retained portion retained in the movable housing, and a resiliently deformable intermediate portion located between the stationary-side retained portion and the movable-side retained portion, and are provided spanning between the stationary housing and the movable housing.

In the present invention, such an electrical connector for circuit boards is characterized in that the intermediate portions, at least in part, are located in the interior space of the electrical connector for circuit boards, the electrical connector for circuit boards has contoured portions made of dielectric material which, relative to the intermediate portions, are positioned on the side opposite the interior space and extend along the intermediate portions while being spaced by a clearance from the intermediate portions, and the contoured portions are capable of following the intermediate portions when the intermediate portions are resiliently deformed in the connector width direction perpendicular to the terminal array direction.

In the present invention, the contoured portions made of dielectric material are provided extending along the intermediate portions of the terminals while being spaced by a clearance from said intermediate portions. The fact that the contoured portions extend along the intermediate portions in this manner makes it possible to adjust the impedance of said intermediate portions and, as a result, achieve an impedance match in the terminals. At such time, the contoured portions are positioned spaced by a clearance from the intermediate portions and, therefore, are not in contact with said intermediate portions. Accordingly, the impedance of the intermediate portions does not drop too low and a good impedance match is therefore easy to achieve. In addition, since the contoured portions are adapted to be capable of following the intermediate portions, the resilient deformation of the intermediate portions and, by extension, the movement of the movable housing are not impeded.

(2) In the invention of (1), the contoured portions may be formed as part of the stationary housing and are capable of lockingly engaging the movable housing in the connector width direction.

(3) In the invention of (1), the contoured portions may be formed separately from the stationary housing and the movable housing, and are capable of lockingly engaging the movable housing in the connector width direction while being retained in the stationary housing.

With configurations such as those of the above-described inventions of (2) and (3), when the movable housing moves in the connector width direction, the contoured portions follow the intermediate portions resiliently deformed in the connector width direction. As a result, it becomes easier to maintain an assured clearance between the contoured portions and intermediate portions and, by extension, a good impedance match even after the movement of the movable housing.

(4) In the invention of (2) or (3), the contoured portions may have no sections abutting the movable housing in the terminal array direction, and the movable housing may be capable of moving in the terminal array direction without interfering with the contoured portions. With such a configuration, the movable housing does not interfere with the contoured portions and can thus move smoothly in the terminal array direction.

(5) In the invention of (1), the contoured portions may be formed as part of the movable housing and are capable of lockingly engaging the stationary housing in the connector width direction.

(6) In the invention of (1), the contoured portions may be formed separately from the stationary housing and the movable housing, and are capable of lockingly engaging the stationary housing in the connector width direction while being retained in the movable housing.

With configurations such as those of the above-described inventions of (5) and (6), when the movable housing moves in the connector width direction, the contoured portions follow the intermediate portions of the terminals as a result of displacement using the locations of locking engagement with the stationary housing as fulcrum points. As a result, it becomes easier to maintain an assured clearance between the contoured portions and intermediate portions and, by extension, a good impedance match even after the movement of the movable housing.

(7) In the invention of (5) or (6), the contoured portions may have no sections abutting the stationary housing in the terminal array direction and may be capable of moving in the terminal array direction along with the movable housing without interfering with the stationary housing. With such an arrangement, when the movable housing moves in the terminal array direction, the contoured portions move along with the movable housing without interfering with the stationary housing, thereby providing for smooth movement of the movable housing.

### Effects of the Invention

The present invention can provide an electrical connector for circuit boards capable of implementing a good impedance match while permitting relative movement of the movable housing with respect to the stationary housing.

### BRIEF DESCRIPTION OF THE DRAWINGS

FIG. 1 is a perspective view of a socket connector and a plug connector according to a first embodiment of the present invention, shown in a state before mating connection.

FIG. 2 is a perspective view illustrating the respective components of the socket connector of FIG. 1 in isolation.

FIG. 3 is a cross-sectional view illustrating a cross-section of the socket connector and plug connector of FIG. 1 taken in a plane perpendicular to the terminal array direction, shown in a state before mating connection.

FIG. 4 is a cross-sectional view illustrating a cross-section of the socket connector and plug connector taken in a plane perpendicular to the terminal array direction, shown in a state after mating connection.

FIG. 5 is a cross-sectional view illustrating a cross-section of the socket connector and plug connector taken in a plane perpendicular to the terminal array direction, shown in a floating state after mating connection.

FIG. 6 is a cross-sectional view illustrating a cross-section of a socket connector according to a second embodiment of the present invention taken in a plane perpendicular to the terminal array direction.

FIG. 7 is a cross-sectional view illustrating a cross-section of a socket connector according to a third embodiment of the present invention taken in a plane perpendicular to the terminal array direction.

FIG. 8 is a cross-sectional view illustrating a cross-section of a socket connector according to a fourth embodiment of the present invention taken in a plane perpendicular to the terminal array direction.

FIG. 9 is a lateral view illustrating a socket connector according to a fifth embodiment of the present invention as seen in the connector width direction.

FIG. 10 is a cross-sectional view illustrating a cross-section of a socket connector according to a sixth embodiment of the present invention taken in a plane perpendicular to the terminal array direction.

FIG. 11 is a cross-sectional view illustrating a cross-section of a socket connector according to a seventh embodiment of the present invention taken in a plane perpendicular to the terminal array direction.

### DETAILED DESCRIPTION

Embodiments of the present invention are described hereinbelow with reference to the accompanying drawings.

### First Embodiment

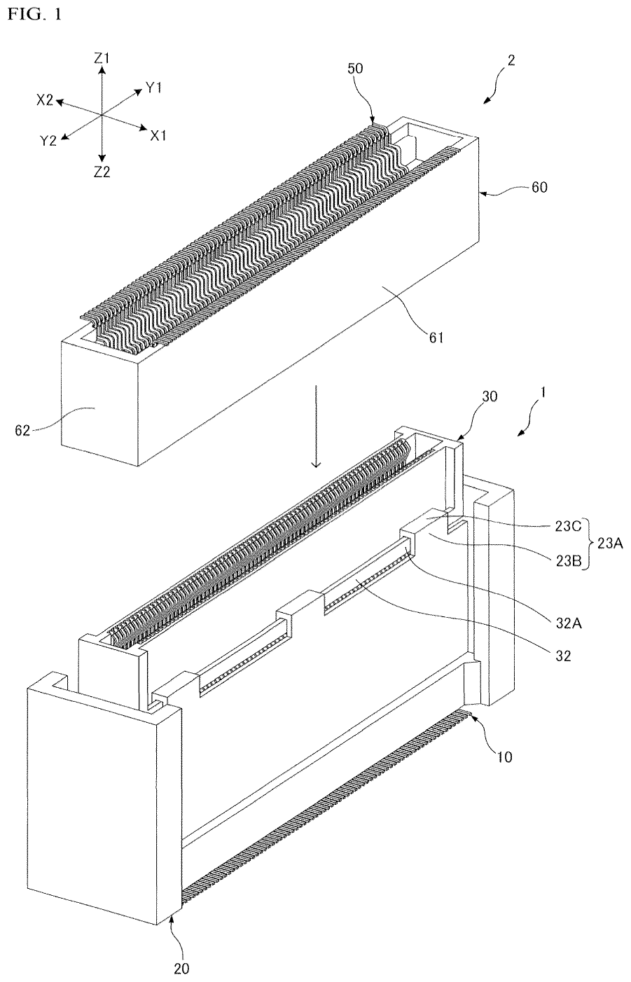

FIG. 1 is a perspective view of a socket connector 1 and a plug connector 2 according to the present embodiment, shown in a state before mating connection. The socket connector 1 is an electrical connector for circuit boards mounted to a mounting face of a circuit board (not shown). In addition, the plug connector 2, which serves as a counterpart connect body (counterpart connector) connected to the socket connector 1, is an electrical connector for circuit boards mounted to a mounting face of another circuit board (not shown). The socket connector 1 and plug connector 2 are matingly connected in the connector height direction (in the up-down direction designated as the Z-axis direction) perpendicular to the mounting faces in an orientation wherein the mounting faces of the circuit boards are in an opposed relationship, and thus form an electrical connector assembly. In the present embodiment, the plug connector 2 is adapted to be matingly connected to the socket connector 1 from above.

The socket connector 1 has multiple socket terminals 10 made of sheet metal, which are arranged side by side such that the terminal array direction is a direction parallel to the mounting face of the circuit board (Y-axis direction), and socket housings 20, 30 (the stationary housing 20 and the movable housing 30 described below) made of plastic or other dielectric material (made of electrically insulating material), which retain the multiple socket terminals 10.

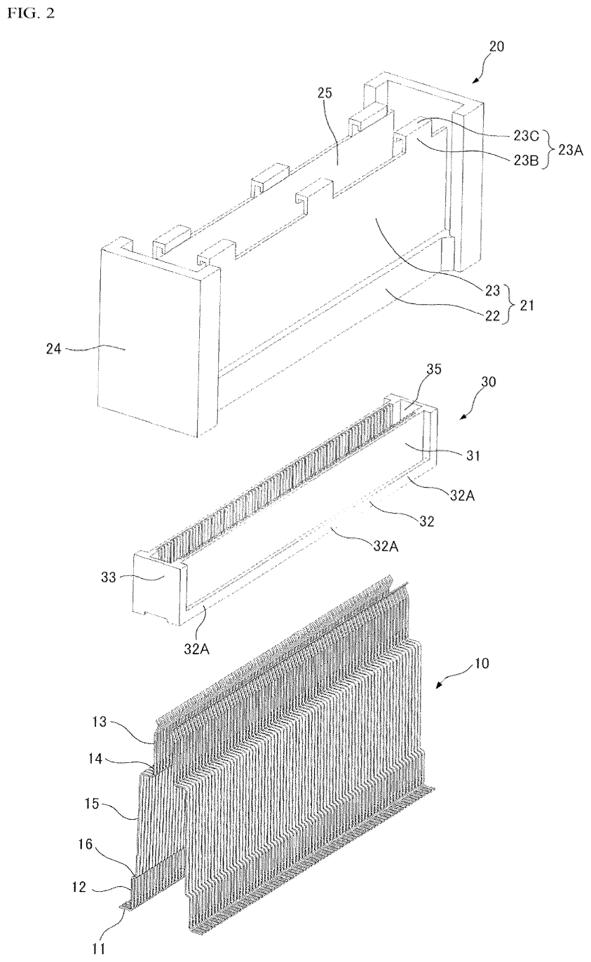

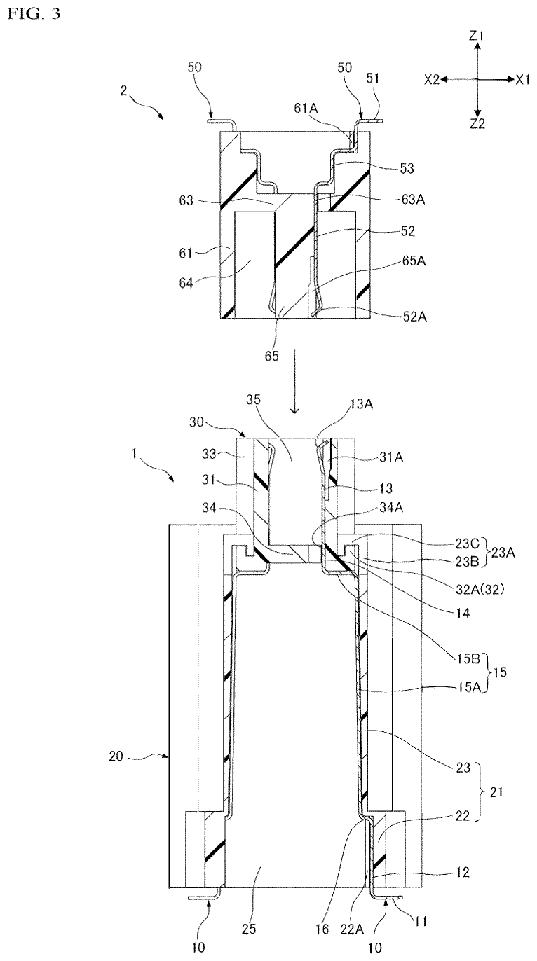

FIG. 2 is a perspective view illustrating the respective components of the socket connector 1 in isolation. FIG. 3 is a cross-sectional view illustrating a cross-section of the socket connector 1 and plug connector 2 before mating connection taken in a plane perpendicular to the terminal array direction at the location of the socket terminals 10. As shown in FIG. 2 and FIG. 3, the socket terminals 10 are arranged in two rows. The two rows of the socket terminals 10 are provided in mutually symmetrical orientations in the connector width direction (X-axis direction) perpendicular to both the terminal array direction (Y-axis direction) and the up-down direction (Z-axis direction). In addition, in the present embodiment, the two rows of the socket terminals 10 are disposed in a staggered pattern, with the socket terminals 10 in one row and the socket terminals 10 in the other row being positioned differently from each other in the terminal array direction.

The socket housings 20, 30 include a stationary housing 20 secured to the circuit board (not shown) through the medium of the socket terminals 10, and a movable housing 30 capable of relative movement with respect to the stationary housing 20. The socket terminals 10 are provided spanning between the stationary housing 20 and the movable housing 30.

The socket terminals 10 are made by bending metal strip-like pieces in the through-thickness direction thereof and, as shown in FIG. 2, are disposed such that the terminal width direction (direction perpendicular to the through-thickness direction of the socket terminals 10) thereof coincides with the terminal array direction (Y-axis direction). As shown in FIG. 2 and FIG. 3, the socket terminals 10 have a connecting portion 11 formed at one end located at the bottom, a stationary-side retained portion 12 extending upwardly from the connecting portion 11, a contact arm portion 13 formed at the other end located upwardly and inwardly of the connecting portion 11 in the connector width direction, a movable-side retained portion 14 extending downwardly from the contact arm portion 13, and an intermediate portion 15 and a transitional portion 16 located between the stationary-side retained portion 12 and the movable-side retained portion 14.

The configuration of the stationary housing 20 and the movable housing 30 will be described before further description of the socket terminals 10. As shown in FIG. 1 and FIG. 2, the stationary housing 20 has a rectangular cylindrical configuration with a generally rectangular parallelepiped-like external shape whose longitudinal direction is the terminal array direction (Y-axis direction). The stationary housing 20 has a pair of lateral walls 21, which extend in the terminal array direction, and a pair of end walls 24, which extend in the connector width direction (X-axis direction) at opposite ends in the terminal array direction and are coupled by the pair of lateral walls 21, with the pair of lateral walls 21 and the pair of end walls 24 forming a peripheral wall. As shown in FIG. 2 and FIG. 3, the end walls 24 span across a range that extends outwardly of the lateral walls 21 in the connector width direction. As shown in FIG. 3, an interior space 25, which is enclosed by the peripheral wall and disposed in the up-down direction, accommodates a portion of the movable housing 30 and a portion of the socket terminals 10. Polyamide (PA) or liquid crystal polymers (LCP) and other engineering plastics, or elastomers, rubbers, and the like are suggested as examples of the dielectric material comprising the stationary housing 20.

The lateral walls 21 have lower walls 22, which make up the bottom portions of said lateral walls 21, and contoured portions 23, which make up sections other than the bottom portions of the lateral walls 21. As shown in FIG. 3, groove-shaped stationary-side retaining portions 22A, which are recessed from the interior wall surface of the lower walls 22 while extending in the up-down direction, are formed in said lower walls 22. The stationary-side retaining portions 22A, whose bottom ends are open, are adapted to retain the stationary-side retained portions 12 of the socket terminals 10 press-fitted from below.

As shown in FIG. 3, the contoured portions 23, which are positioned inwardly of the lower walls 22 in the connector width direction, are formed thinner than said lower walls 22. In the present embodiment, as shown in FIG. 3, the thickness dimensions of the contoured portions 23 gradually increase as one moves upward. In addition, the contoured portions 23 are positioned outwardly relative to the hereinafter-described first leg portions 15A of the socket terminals 10 in the connector width direction, i.e., on the side opposite the interior space 25. The contoured portions 23, which are positioned spaced by a slight clearance from the exterior side faces (major faces located outwardly in the connector width direction) of the first leg portions 15A in the connector width direction, extend along said first leg portions 15A in the up-down direction. In the present embodiment, the contoured portions 23 are devoid of intermittent sections in the terminal array direction, i.e., are continuously solid over the entire extent thereof in the terminal array direction.

In addition, as shown in FIGS. 1 to 3, engaging portions 23A lockingly engageable with the movable housing 30 are provided in the top portions of the contoured portions 23 at multiple locations (3 locations in the present embodiment) in the terminal array direction. The engaging portions 23A have a rising portion 23B, which extends upwardly from the top end of the wall parallel to the first leg portion 15A in the contoured portion 23, and a hooked portion 23C, which extends from the top end of the rising portion 23B. As shown in FIGS. 1 to 3, the hooked portion 23C has a claw-like configuration that extends inwardly in the connector width direction from the top end of the rising portion 23B and then extends further downward.

As shown in FIG. 3, the movable housing 30 is inserted into and disposed in the interior space 25 of the stationary housing 20 from below, and the lower portion of the movable housing 30 is accommodated in the top portion of the interior space 25. As shown in FIG. 2, the movable housing 30 has a pair of long walls 31, which extend in the terminal array direction, a pair of engageable walls 32, which are coupled to the bottom portions of the long walls 31 while extending in the terminal array direction, a pair of short walls 33, which extend in the connector width direction (X-axis direction) at opposite ends in the terminal array direction and are coupled by the pair of long walls 31 and the pair of engageable walls 32, and a bottom wall 34 (see FIG. 3), which seals the space enclosed by the peripheral wall made up of the pair of long walls 31 and the pair of short walls 33 from below. The upwardly open space enclosed by the aforementioned peripheral wall forms a socket-side receiving portion 35 intended for receiving part of the plug connector 2. Polyamide (PA), liquid crystal polymers (LCP), and other engineering plastics and the like are suggested as examples of the dielectric material comprising the movable housing 30.

As shown in FIG. 3, socket terminal groove portions 31A recessed from the interior wall surface of said long walls 31 are formed in a side-by-side arrangement in the top portion of the long walls 31. The socket terminal groove portions 31A, which extend in the up-down direction along the top portions of the contact arm portions 13 of the socket terminals 10, are capable of permitting resilient deformation of the top portions of said contact arm portions 13.

As shown in FIG. 3, the engageable walls 32 first extend outwardly in the connector width direction from the bottom end portions of the long walls 31 and then extend upwardly, and the shape of their cross-section taken in a plane perpendicular to the terminal array direction has a claw-like configuration. As shown in FIG. 1 and FIG. 2, the sections of the engageable walls 32 positioned in alignment with the engaging portions 23A of the stationary housing 20 in the terminal array direction make up engageable portions 32A lockingly engageable with said engaging portions 23A. As shown in FIG. 3, the engageable portions 32A are adapted to receive the hooked portions 23C of the engaging portions 23A in the upwardly open groove portions, as a result of which the hooked portions 23C are capable of lockingly engaging the engageable portions 32A in the connector width direction.

In the present embodiment, the hooked portions 23C have no sections abutting the engageable walls 32 in the terminal array direction. Accordingly, the movable housing 30 as a whole is capable of moving in the terminal array direction without interfering with the stationary housing 20.

As shown in FIG. 3, movable-side retaining portions 34A intended for press-fittingly retaining the movable-side retained portions 14 of the socket terminals 10 are formed in the bottom wall 34 as aperture portions disposed through the bottom wall 34 in the up-down direction.

Going back to the description of the socket terminals 10, as can be seen in FIG. 3, the connecting portions 11, which extend outwardly in the connector width direction at locations downward of the bottom face of the stationary housing 20, are adapted to be solder-connected to corresponding circuits (not shown) on the mounting face of the circuit board. The stationary-side retained portions 12, which are bent at the inward ends of the connecting portions 11 in the connector width direction and extend upwardly in a rectilinear configuration, are press-fittingly retained by the stationary-side retaining portions 22A of the stationary housing 20 with the help of press-fitting projections formed on opposite side edges (edges extending in the up-down direction on opposite sides in the terminal width direction).

The top portions of the contact arm portions 13, which extend in the up-down direction along the interior wall surfaces of the long walls 31 of the movable housing 30, are adapted to be resiliently deformable in the connector width direction (in the through-thickness direction of the contact arm portions 13). Specifically, as shown in FIG. 3, the bottom portions of the contact arm portions 13, which are in surface contact with the interior wall surfaces of the long walls 31, are supported by said interior wall surfaces from the outside in the connector width direction. As shown in FIG. 3, the top portions of the contact arm portions 13 are positioned in alignment with the socket terminal groove portions 31A of the long walls 31 in the up-down direction, and resilient deformation thereof directed outwardly in the connector width direction is permitted by the socket terminal groove portions 31A when placed in contact with plug terminals 50, i.e., the counterpart terminals. Contact portions 13A intended for contacting the plug terminals 50 are formed by being bent so as to protrude inwardly in the connector width direction at the top ends of the contact arm portions 13.

As shown in FIG. 3, the movable-side retained portions 14, which extend downwardly from the bottom ends of the contact arm portions 13 in a rectilinear configuration, are retained by the bottom wall 34 of the movable housing 30. Specifically, the movable-side retained portions 14 are press-fittingly retained by the movable-side retaining portions 34A of the movable housing 30 with the help of press-fitting projections formed on opposite side edges (edges extending in the up-down direction on opposite sides in the terminal width direction).

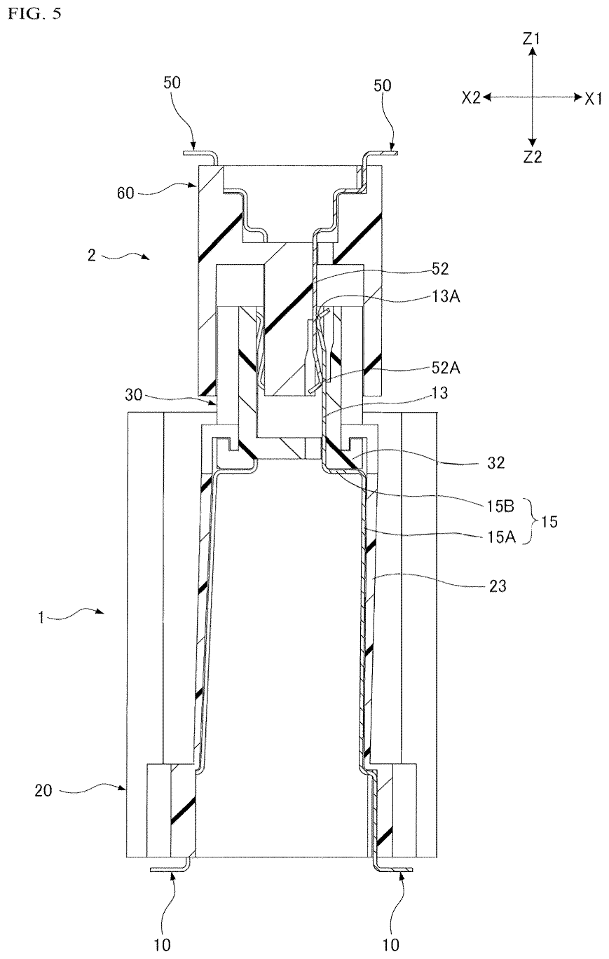

The overall shape of the intermediate portions 15, which have a first leg portion 15A extending in the up-down direction and a second leg portion 15B extending in the connector width direction, is generally an inverted L-shaped configuration. The first leg portions 15A, which extend in a rectilinear configuration along the interior wall surfaces of the contoured portions 23 of the stationary housing 20, are adapted to be resiliently deformable in the connector width direction. The movement (floating) of the movable housing 30 in the connector width direction is permitted due to resilient deformation of these first leg portions 15A (see FIG. 5). The first leg portions 15A are coupled to the top ends of the stationary-side retained portions 12 through the medium of transitional portions 16 extending outwardly from the bottom ends thereof in the connector width direction. As shown in FIG. 3, the first leg portions 15A are provided in positions spaced by a clearance from the interior wall surfaces of the contoured portions 23 in the connector width direction.

The clearance between the contoured portions 23 and the first leg portions 15A is dimensioned to assure appropriate impedance in the socket terminals 10. Here, the value of the “appropriate impedance” is set within a predetermined allowable range and, accordingly, the aforementioned dimensions are set within a predetermined allowable range. The contoured portions 23, which are resiliently deformable in the connector width direction along with the first leg portions 15A, are also adapted such that a clearance dimensioned within the aforementioned allowable range is assured with respect to the first leg portions 15A even in the resiliently deformed state (see FIG. 5).

In addition, the first leg portions 15A are also resiliently deformable in the terminal array direction. The movement (floating) of the movable housing 30 in the terminal array direction is permitted by resilient deformation of the first leg portions 15A.

The second leg portions 15B, which are bent at right angles at the top ends of the first leg portions 15A and extend inwardly in the connector width direction, are coupled to the bottom ends of the movable-side retained portions 14. The second leg portions 15B extend in a rectilinear configuration along the bottom faces (lower faces) of the engageable walls 32 of the movable housing 30. As shown in FIG. 3, the second leg portions 15B are provided in positions spaced by a clearance from the bottom faces of the engageable walls 32 in the connector width direction.

The clearance between the engageable walls 32 and second leg portions 15B is dimensioned to assure appropriate impedance in the socket terminals 10. Here, the value of the “appropriate impedance” is set within a predetermined allowable range and, accordingly, the aforementioned dimensions are set within a predetermined allowable range. Even in the resiliently deformed state of the second leg portions 15B, a clearance dimensioned within the aforementioned allowable range is ensured between the engageable walls 32 and second leg portions 15B.

In the present embodiment, as described above, the contoured portions 23 and the first leg portions 15A as well as the engageable walls 32 and the second leg portions 15B are positioned spaced by a clearance dimensioned to assure appropriate impedance and are not in contact with one another. Accordingly, a good characteristic impedance match is achieved without an excessive drop in the characteristic impedance of the intermediate portions 15.

The procedure of assembly of the socket connector 1 will be described next. First, the socket terminals 10 are attached to the movable housing 30 by press-fitting the movable-side retained portions 14 of the socket terminals 10 into the movable-side retaining portions 34A of the movable housing 30 from below. The movable housing 30, to which the socket terminals 10 are attached, is then introduced into the interior space 25 of the stationary housing 20 from below, and the stationary-side retained portions 12 of the socket terminals 10 are press-fitted into the stationary-side retaining portions 22A of the stationary housing 20. As a result, the socket terminals 10 are attached to the stationary housing 20. At such time, the hooked portions 23C of the engaging portions 23A of the stationary housing 20 enter the groove portions of the engageable portions 32A of the movable housing 30 from above. This completes the assembly of the socket connector 1.

The configuration of the plug connector 2, i.e., the counterpart connector, will be described next. The plug connector 2 has multiple plug terminals 50, which are made of sheet metal and serve as counterpart terminals, and a plug housing 60, which is made of plastic or other dielectric material (made of electrically insulating material) and retains the plug terminals 50. Polyamide (PA) or liquid crystal polymers (LCP) and other engineering plastics, etc., are suggested as examples of the dielectric material comprising the plug housing 60. As shown in FIG. 1 and FIG. 3, the plug terminals 50 are arranged in two rows such that the terminal array direction is the same direction (Y-axis direction) as the array direction of the socket terminals 10. The two rows of plug terminals 50 are disposed in a staggered pattern in alignment with the socket terminals 10.

The plug terminals 50, which are made by bending metal strip-like pieces in the through-thickness direction, are disposed such that the terminal width direction thereof coincides with the terminal array direction. As shown in FIG. 3, the plug terminals 50 have a connecting portion 51 formed at one end (top end in FIG. 3), a contact arm portion 52 formed at the other end (bottom end in FIG. 3), and a coupling portion 53 bent in a stepped configuration between the connecting portion 51 and the contact arm portion 52.

The configuration of the plug housing 60 will be described before describing the plug terminals 50 further. As shown in FIG. 1, the plug housing 60 has a rectangular parallelepiped-like external shape whose longitudinal direction is the terminal array direction (Y-axis direction). The plug housing 60 has a pair of lateral walls 61 extending in the terminal array direction and a pair of end walls 62 extending in the connector width direction (X-axis direction) and coupling the end portions of the pair of lateral walls 61, with the pair of lateral walls 61 and the pair of end walls 62 forming a peripheral wall. As shown in FIG. 3, an interior space formed as a result of being enclosed by this peripheral wall is separated into upper and lower parts by an intervening wall 63 provided at an intermediate location in the up-down direction and is adapted to be capable of receiving a portion of the socket connector 1 in a plug-side receiving portion 64, i.e., the lower interior space. In addition, a protruding wall 65, which protrudes downwardly from the lower face of the intervening wall 63 while extending in the terminal array direction, is provided within the plug-side receiving portion 64. Plug terminal groove portions 65A, which are recessed into the lateral faces of the protruding wall 65 while extending in the up-down direction, are formed in a side-by-side arrangement in the bottom portion of the protruding wall 65.

Going back to the description of the plug terminals 50, the connecting portions 51, which are located upwardly of the bottom face of the plug housing 60 (upper face in FIG. 3) and extend outwardly in the connector width direction from the top ends of the coupling portions 53, are adapted to be solder-connected to corresponding circuits on the mounting face of the circuit board (not shown). The contact arm portions 52 are of the same shape as the contact arm portions 13 of the socket terminals 10. As shown in FIG. 3, the contact arm portions 52, which extend downwardly from the bottom ends of the coupling portions 53 along the lateral faces of the protruding wall 65 of the plug housing 60, are adapted to be resiliently deformable in the connector width direction (in the through-thickness direction of the contact arm portions 52). Specifically, as shown in FIG. 3, the top portions of the contact arm portions 52, which are in surface contact with the lateral faces of the protruding wall 65, are supported from the inside in the connector width direction by said lateral faces. The bottom portions of the contact arm portions 52, as shown in FIG. 3, are positioned in alignment with the plug terminal groove portions 65A of the protruding wall 65 in the up-down direction, and the resilient deformation thereof directed inwardly in the connector width direction is permitted by the plug terminal groove portions 65A when placed in contact with the socket terminals 10. Contact portions 52A intended for contacting the socket terminals 10 are formed in the bottom end portions of the contact arm portions 52 by being bent so as to protrude outwardly in the connector width direction.

The plug terminals 50 are attached to said plug housing 60 from the side of the bottom face (upper face side in FIG. 3) of the plug housing 60. Specifically, while the bottom end portions of the coupling portions 53 are press-fittingly retained by plug terminal retaining aperture portions 63A formed through the intervening wall 63, the top end portions of the coupling portions 53 are press-fittingly retained by plug terminal retaining groove portions 61A recessed from the interior wall surfaces of the lateral walls 61.

The operation of mating of the socket connector 1 and plug connector 2 will be described next. First, the socket connector 1 and plug connector 2 are mounted to the mounting faces of the respectively corresponding circuit boards (not shown) using solder connections. Namely, the connecting portions 11 of the socket terminals 10 are solder-connected to corresponding circuits on one circuit board and the connecting portions 51 of the plug terminals 50 are solder-connected to corresponding circuits on the other circuit board, thereby attaching the socket connector 1 and plug connector 2 to the respectively corresponding circuit boards.

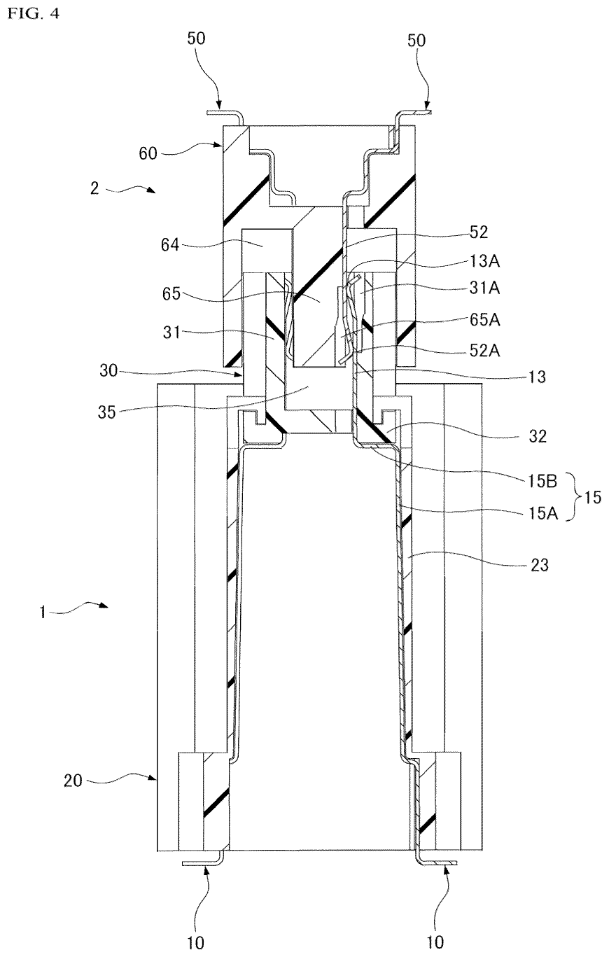

Next, as shown in FIG. 1 and FIG. 3, the plug connector 2 is positioned above the socket connector 1 in an orientation wherein the plug-side receiving portion 64 (see FIG. 3) is downwardly open. The plug connector 2, while being held in that orientation, is lowered, and the protruding wall 65 is introduced into the socket-side receiving portion 35 of the movable housing 30 of the socket connector 1 from above. At the same time, the peripheral wall of the movable housing 30 enters the plug-side receiving portion 64 of the plug connector 2 from below. As a result, as shown in FIG. 4, the socket connector 1 and plug connector 2 are mated.

When the plug connector 2 is mated with the socket connector 1, as shown in FIG. 4, the contact arm portions 13 of the socket terminals 10, while undergoing resilient deformation, make contact with the top portions, i.e., the proximal sections, of the contact arm portions 52 of the plug terminals 50 under contact pressure using the contact portions 13A. In addition, the contact arm portions 52 of the plug terminals 50, while undergoing resilient deformation, make contact with bottom portions, i.e., the proximal sections, of the contact arm portions 13 of the socket terminals 10 under contact pressure using the contact portions 52A. Namely, as shown in FIG. 4, the socket terminals 10 and the plug terminals 50 are placed in 2-point contact and are in electrical communication. Since in the present embodiment the top portions of the contact arm portions 52 are supported by the protruding wall 65 of the plug housing 60 and, in addition, the bottom portions of the contact arm portions 13 are supported by the long walls 31 of the movable housing 30, the socket terminals 10 and plug terminals 50 are placed in contact with one another under sufficiently high contact pressure. This completes the operation of mating connection of the socket connector 1 and plug connector 2.

If there is no misalignment in the relative positions of the socket connector 1 and plug connector 2 at the moment of completion of the operation of mating connection, the socket connector 1 and plug connector 2 will be in the standard position illustrated in FIG. 4. In this standard position, the first leg portions 15A of the socket terminals 10 are positioned to provide a predetermined clearance from the interior wall surfaces of the contoured portions 23 of the stationary housing 20 in the connector width direction. The second leg portions 15B of the socket terminals 10 are positioned to provide a predetermined clearance from the bottom faces of the engageable walls 32 of the movable housing 30 in the up-down direction.

Even if the relative positions of the socket connector 1 and plug connector 2 are misaligned immediately prior to the start of the operation of mating connection of the connectors, in the process of connector mating and after connector mating, the movable housing 30 moves (floats) towards the direction in which the misalignment has taken place and, as a result, makes mating connection possible upon absorption of the misalignment (see FIG. 5).

In addition, even if the socket connector 1 and plug connector 2 are in the standard position (see FIG. 4) at the moment of completion of the operation of mating connection, when the connectors are later used, for example, in a vibration-generating environment, their vibration is absorbed by the floating action of the movable housing 30 of the socket connector 1.

FIG. 5 is a cross-sectional view of the socket connector 1 and plug connector 2 after mating connection, with the movable housing 30 illustrated in a floating state. FIG. 5 illustrates a cross-section taken in a plane perpendicular to the terminal array direction at the location of a socket terminal 10. In addition, FIG. 5 illustrates a state in which the movable housing 30 is floating in the connector width direction (X-axis direction) toward the X1 side. If the movable housing 30 floats toward the X1 side, the first leg portions 15A of the two socket terminals 10 illustrated in FIG. 5, i.e., the two socket terminals 10 located on the X1 side and on the X2 side, are resiliently deformed in a manner to tilt toward the X1 side using the areas proximate to the bottom end portions of said first leg portions 15A as fulcrum points.

As shown in FIG. 5, when the movable housing 30 moves toward the X1 side, the contoured portion 23 of the stationary housing 20 on the X1 side is resiliently deformed in a manner to tilt toward the X1 side in concert with the resilient deformation of the first leg portion 15A of the socket terminal 10 on the X1 side using the area proximate to the bottom end portion thereof as a fulcrum point. At such time, the contoured portion 23 on the X2 side is resiliently deformed toward the X1 side in concert with the resilient deformation of the first leg portion 15A on the X2 side. In the present embodiment, the thickness dimensions (dimensions in the X-axis direction) of the contoured portions 23 are smallest in the bottom end portions of said contoured portions 23. Accordingly, the contoured portions 23, which are rendered more resiliently deformable in the connector width direction (X-axis direction) using the areas proximate to the bottom end portions thereof as fulcrum points, can readily follow the first leg portions 15A of the socket terminals 10.

In the present embodiment, as described above, when the movable housing 30 floats in the connector width direction, the two contoured portions 23 of the stationary housing 20 are resiliently deformed in the connector width direction along with the first leg portions 15A adjacent to said contoured portions 23. In this manner, the contoured portions 23 are capable of following the first leg portions 15A and, therefore, do not interfere with the resilient deformation of the first leg portions 15A and, by extension, the movement of the movable housing 30.

In addition, even in the resiliently deformed state, the contoured portions 23 maintain a clearance from the first leg portions 15A in the previously discussed predetermined allowable range and do not come into contact with the first leg portions 15A. In addition, as shown in FIG. 5, the second leg portions 15B of the socket terminals 10 are not resiliently deformed when floating in the connector width direction.

Even though the movable housing 30 floats in this manner, the clearance formed between the contoured portions 23 of the stationary housing 20 and the first leg portions 15A of the socket terminals 10 is maintained. Accordingly, the characteristic impedance of the first leg portions 15A does not drop too low and the characteristic impedance match achieved in the socket terminals 10 can thus be maintained.

In addition, in the present embodiment, as described above, the contoured portions 23 of the stationary housing 20 are resiliently deformed in concert with the movement of the movable housing 30 along with the first leg portions 15A of the socket terminals 10 using the areas proximate to the bottom end portions thereof as fulcrum points. Accordingly, it becomes easier to maintain an assured clearance therebetween and, by extension, a good characteristic impedance match even in the resiliently deformed state of the contoured portions 23 and first leg portions 15A.

In addition, if the movable housing 30 floats in the terminal array direction, the floating action thereof is permitted due to the fact that the intermediate portions 15 of the socket terminals 10 undergo resilient deformation in the terminal array direction. In the present embodiment, the contoured portions 23 have no sections abutting the movable housing 30 in the terminal array direction. Accordingly, the movable housing 30 does not interfere with the contoured portions 23 and can thus move smoothly in the terminal array direction.

At such time, the contoured portions 23 themselves move in concert with the resiliently deformed intermediate portions 15 while keeping the first leg portions 15A of the socket terminals 10 covered and being free of resilient deformation in the terminal array direction. In the present embodiment, the contoured portions 23 are continuously solid over the entire extent thereof in the terminal array direction and thus reliably cover the first leg portions 15A of the intermediate portions 15 even when the intermediate portions 15 are resiliently deformed in the terminal array direction, as a result of which a good characteristic impedance match can be assured in the socket terminals 10.

### Second Embodiment

While in the first embodiment the contoured portions 23 were formed as part of the stationary housing 20, in the second embodiment, the configuration differs from the first embodiment in that the contoured portions are formed separately from the stationary housing and the movable housing. In the present embodiment, the discussion will focus on points of difference from the first embodiment, and sections identical to the first embodiment, except for the contoured portions, will be assigned reference numerals obtained by adding “100” to the reference numerals used in the first embodiment, and further discussion thereof will be omitted.

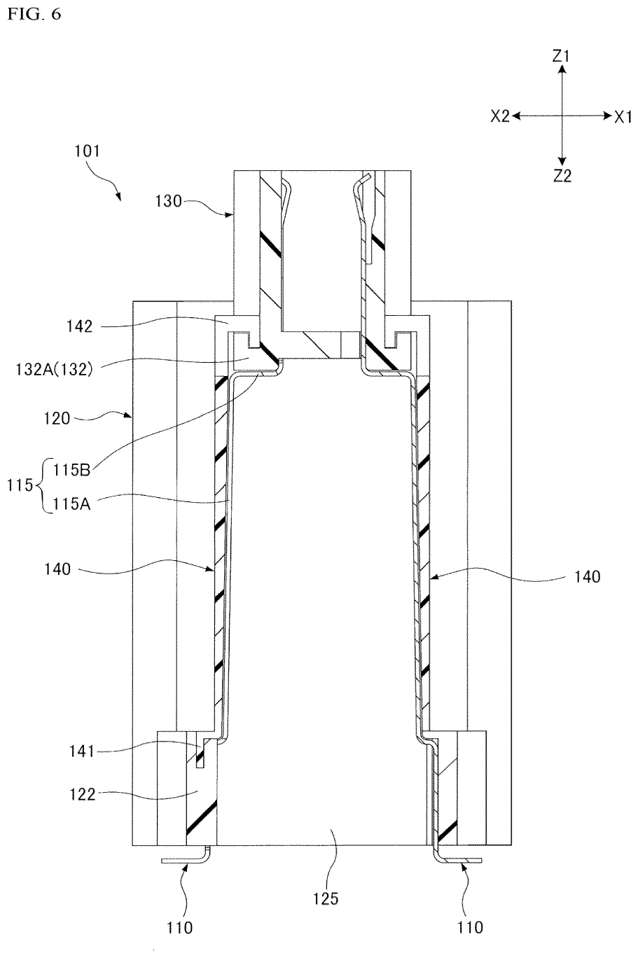

FIG. 6 is a cross-sectional view illustrating a cross-section of a socket connector 101 according to the second embodiment taken in a plane perpendicular to the terminal array direction. FIG. 6 illustrates a cross-section taken at the location of socket terminals 110 in the terminal array direction (Y-axis direction). In the present embodiment, the contoured portions 140 are made of dielectric material (electrically insulating material), and constitute members separate from the stationary housing 120 and movable housing 130. Polyamide (PA) or liquid crystal polymers (LCP) and other engineering plastics, or elastomers, rubbers, and the like are suggested as examples of the dielectric material comprising the contoured portions 140. The shape of the stationary housing 120 is obtained by omitting the contoured portions 23 from the stationary housing 20 of the first embodiment. In addition, polyamide (PA) or liquid crystal polymers (LCP) and other engineering plastics, etc., are suggested as examples of the dielectric material comprising the stationary housing 120 and movable housing 130.

The shape of the contoured portions 140 is obtained by providing securing portions 141, retained by the stationary housing 120, at the bottom end portions of the contoured portions 23 of the first embodiment. As far as the securing portions 141 are concerned, as shown in FIG. 6, the contoured portions 140 extend outwardly in the connector width direction from the bottom ends of the walls extending along the first leg portions 115A of the socket terminals 110 and then extend further downward, and the shape of their cross-section perpendicular to the terminal array direction has an inverted L-shaped configuration. The securing portions 141 are embedded and secured in the lower walls 122 of the stationary housing 120. In the present embodiment, the securing portions 141 are retained by said lower walls 122 as a result of being integrally molded with the lower walls 122. The sections of the contoured portions 140 other than the securing portions 141 are of the same shape as the contoured portions 23 of the first embodiment. As shown in FIG. 6, the contoured portions 140 are enabled to lockingly engage the engageable portions 132A of the movable housing in the connector width direction using the engaging portions 142 provided at the top.

As shown in FIG. 6, the contoured portions 140 are provided with a slight clearance from the first leg portions 115A of the socket terminals 110 formed in the connector width direction. In the same manner as in the first embodiment, this clearance is dimensioned to ensure appropriate impedance in the socket terminals 110. When the movable housing 130 floats in the connector width direction, the contoured portions 140 are resiliently deformed in a manner to tilt in concert with the resilient deformation of the first leg portions 115A and, by extension, the movement of the movable housing 130, using as fulcrum points the areas proximate to the bottom end portions of the walls extending along the first leg portions 115A, i.e., the areas proximate to the top end portions of the securing portions 141. Even in such a floating state, the clearance formed between the contoured portions 140 and first leg portions 115A is maintained and, as a result, the characteristic impedance match achieved in the socket terminals 110 can be maintained.

### Third Embodiment

Although in the second embodiment the contoured portions 140 constituted members separate from the stationary housing 120 and movable housing 130, in the third embodiment, the configuration differs from the second embodiment in that the contoured portions are formed as part of the movable housing. In the present embodiment, the discussion will focus on points of difference from the second embodiment and, except for the contoured portions, sections identical to the second embodiment will be assigned reference numerals obtained by adding “100” to the reference numerals used in the second embodiment, and further discussion thereof will be omitted.

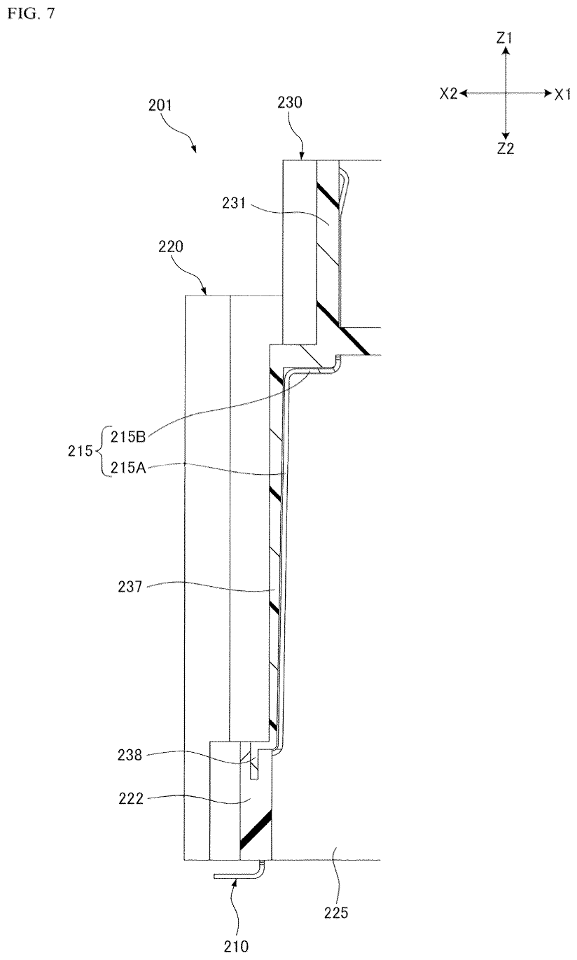

FIG. 7 is a cross-sectional view illustrating a cross-section of a socket connector 201 according to the third embodiment taken in a plane perpendicular to the terminal array direction. In FIG. 7, illustration of the half on the X1 side in the connector width direction has been omitted. In the present embodiment, the shape of the movable housing 230 is obtained by providing contoured portions and securing portions in the movable housing 130 of the second embodiment. Polyamide (PA) or liquid crystal polymers (LCP) and other engineering plastics, or elastomers, rubbers, and the like are suggested as examples of the dielectric material comprising the movable housing 230. In addition, polyamide (PA) or liquid crystal polymers (LCP) and other engineering plastics, etc., are suggested as examples of the dielectric material comprising the stationary housing 220. As shown in FIG. 7, the movable housing 230 has no sections corresponding to the engageable walls 132 in the second embodiment. The movable housing 230 of the present embodiment has contoured portions 237, which extend from the bottom end portions of the long walls 231, and securing portions 238, which extend from the bottom end portions of said contoured portions 237.

The contoured portions 237 project outwardly in the connector width direction from the bottom end portions of the long walls 231 and then extend downwardly, with the shape of their cross-section relative to the terminal array direction having a generally inverted L-shaped configuration. As shown in FIG. 7, in the same manner as in the first embodiment and second embodiment, in the contoured portions 237, the walls extending along the first leg portions 215A of the socket terminals 210 have a plate-like configuration whose thickness dimensions gradually increase as one moves upward. In addition, the securing portions 238, which are similar in shape to the second embodiment, are embedded and rigidly retained in the lower walls 222 of stationary housing 220.

As shown in FIG. 7, the contoured portions 237 are provided with a slight clearance from the first leg portions 215A of the socket terminals 210 formed in the connector width direction. In the same manner as in the first embodiment and second embodiment, this clearance is dimensioned to ensure appropriate impedance in the socket terminals 210. When the movable housing 230 floats in the connector width direction, the contoured portions 237 are resiliently deformed in a manner to tilt in concert with the resilient deformation of the first leg portions 215A and, by extension, the movement of the movable housing 230, using as fulcrum points the areas proximate to the bottom end portions of the walls extending along the first leg portions 215A, i.e., the areas proximate to the top end portions of the securing portions 238. Even in such a floating state, the clearance formed between the contoured portions 237 and first leg portions 215A is maintained and, as a result, the characteristic impedance match achieved in the socket terminals 210 can be maintained.

Although in the present embodiment the securing portions 238 extending from the bottom end portions of the contoured portions 237 are retained by the stationary housing 220, and the contoured portions 237 and, by extension, the movable housing 230 therefore do not move in the terminal array direction, as a substitute variation, the movable housing may be made capable of moving in the terminal array direction. Specifically, for example, instead of the securing portions 238, engaging portions of the same shape as the engaging portions 23A of the first embodiment may be provided extending from the bottom end portions of said contoured portions 237 and engageable portions of the same shape as the engageable portions 32A of the first embodiment may be provided in the top portions of the lower walls 222 of the stationary housing 220.

In this variation, the engaging portions and engageable portions are lockingly engaged with one another in the connector width direction. Therefore, when the movable housing floats in the connector width direction, the contoured portions follow the first leg portions of the intermediate portions of the terminals by undergoing resilient deformation in a tilting manner using the locations of locking engagement of the aforementioned engaging portions and the aforementioned engageable portions as fulcrum points. In addition, the aforementioned engaging portions and the aforementioned engageable portions do not abut (interfere with) each other in the terminal array direction. Accordingly, smooth movement, i.e., floating, of the movable housing in the terminal array direction is made possible.

### Fourth Embodiment

Although in the second embodiment the contoured portions 140 constituted members separate from the stationary housing 120 and movable housing 130, in the fourth embodiment the configuration differs from the second embodiment in that one part of the contoured portions is formed as part of the stationary housing and the other part of the contoured portions is formed as part of the movable housing. In the present embodiment, the discussion will focus on points of difference from the second embodiment, and sections identical to the second embodiment will be assigned reference numerals obtained by adding “200” to the reference numerals used in the second embodiment, and further discussion thereof will be omitted.

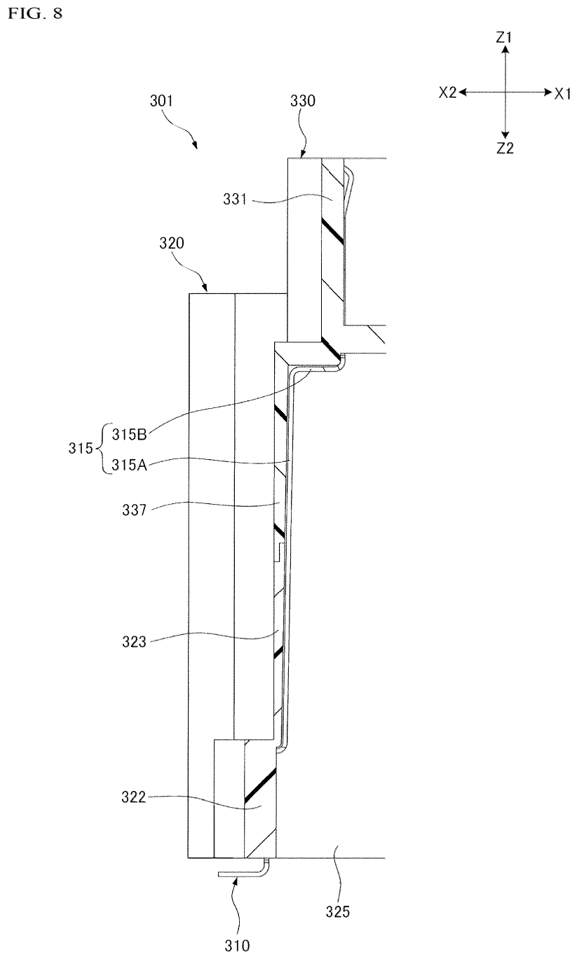

FIG. 8 is a cross-sectional view illustrating a cross-section of a socket connector 301 according to the fourth embodiment taken in a plane perpendicular to the terminal array direction. In FIG. 8, illustration of the half on the X1 side in the connector width direction has been omitted. In the present embodiment, the stationary housing 320 has stationary-side contoured portions 323 and the movable housing 330 has movable-side contoured portions 337. Polyamide (PA) or liquid crystal polymers (LCP) and other engineering plastics, or elastomers, rubbers, and the like are suggested as examples of the dielectric material comprising the stationary housing 320 and movable housing 330.

The shape of the stationary-side contoured portions 323, which extend upwardly from the top end portions of the lower walls 322 of the stationary housing 320, is obtained by omitting the top half of the contoured portions 23 of the first embodiment (see FIG. 3). The shape of the movable-side contoured portions 337, which extend downwardly from the bottom end portions of the long walls 331 of the movable housing 330 in a generally inverted L-shaped configuration, is obtained by omitting the bottom half of the contoured portions 237 of the third embodiment (see FIG. 7).

The top end portions of the stationary-side contoured portions 323 have their exterior half in the thickness direction (connector width direction) cut away, which makes it thinner than other parts. The bottom end portions of the movable-side contoured portions 337 have their interior half in the thickness direction (connector width direction) cut away, which makes it thinner than other parts. As a result, as shown in FIG. 8, the top end portions of the stationary-side contoured portions 323 and the bottom end portions of the movable-side contoured portions 337 are lockingly engaged with each other in the connector width direction.

As shown in FIG. 8, in the same manner as in the first through third embodiments, the walls formed conjointly by the stationary-side contoured portions 323 and movable-side contoured portions 337 have a plate-like configuration whose thickness dimensions gradually increase as one moves upward. These walls are provided with a slight clearance from the first leg portions 315A of the socket terminals 310 formed in the connector width direction. In the same manner as in the first through third embodiments, this clearance is dimensioned to ensure appropriate impedance in the socket terminals 310. When the movable housing 330 floats in the connector width direction, the aforementioned walls are resiliently deformed in a manner to tilt in concert with the resilient deformation of the first leg portions 315A and, by extension, the movement of the movable housing 330, using the areas proximate to the bottom end portions of the stationary-side contoured portions 323 as fulcrum points. Even in such a floating state, the clearance formed between the aforementioned walls and the first leg portions 315A is maintained and, as a result, the characteristic impedance match achieved in the socket terminals 310 can be maintained.

In addition, in the present embodiment, the top end portions of the stationary-side contoured portions 323 and the bottom end portions of the movable-side contoured portions 337 have no sections abutting each other in the terminal array direction. Accordingly, it becomes possible for the movable housing 330 to smoothly move (float) in the terminal array direction.

### Fifth Embodiment

While in the first embodiment the contoured portions 23 are formed to be continuously solid over the entire extent thereof in the terminal array direction, in the fifth embodiment, the contoured portions have slits formed therein at predetermined intervals in the terminal array direction, as a consequence of which they are rendered discontinuous in the terminal array direction and, in this respect, the configuration is made different from the first embodiment. In the present embodiment, the emphasis is on differences from the first embodiment, and sections identical to the first embodiment are assigned reference numerals obtained by adding “400” to the reference numerals used in the first embodiment and further discussion thereof is omitted.

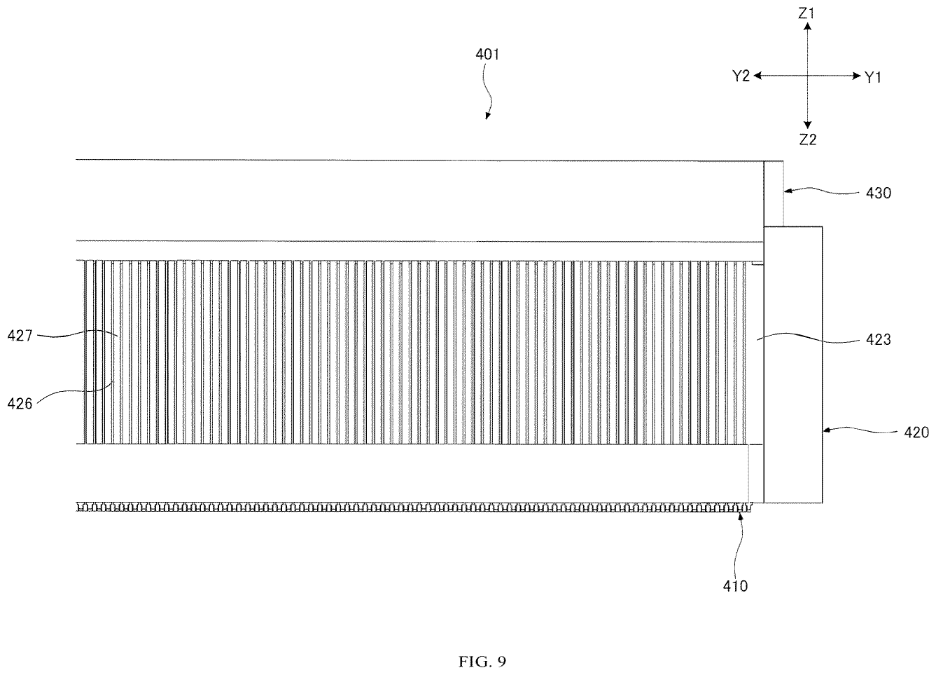

FIG. 9 is a lateral view illustrating a socket connector 401 according to the fifth embodiment as seen in the connector width direction. In FIG. 9, illustration of the end portion on the Y2 side in the terminal array direction (Y-axis direction) has been omitted. In the present embodiment, the top portions of the contoured portions 423 of the stationary housing 420 are secured to the bottom portion of the stationary housing 430 and, in this respect, the configuration differs from the socket connector 1 of the first embodiment, in which the contoured portions 23 are not secured to the movable housing 30.

As shown in FIG. 9, slits 426 are formed at locations between every two socket terminals 410 in the terminal array direction in the contoured portions 423 provided in the stationary housing 420. The slits 426, which extend continuously over substantially the entire extent of the contoured portions 423 in the up-down direction (Z-axis direction), are formed extending in the through-thickness direction of the contoured portions 423. As a result, thin strips 427 are formed on opposite sides of each slit 426 in the terminal array direction in the contoured portions 423. The thin strips 427 are formed to substantially the same width dimensions as the intermediate portions of the socket terminals 410 (not shown in FIG. 7). Accordingly, the thin strips 427 cover the intermediate portions positioned in alignment with said thin strips 427.

In the present embodiment, the contoured portions 423 are formed by the multiple thin strips 427 and are discontinuous in the terminal array direction. Accordingly, in comparison with the first embodiment in which the contoured portions 23 are formed to be continuously solid over the entire extent thereof in the terminal array direction, in the present embodiment, the contoured portions 423 become more resiliently deformable in the connector width direction, which facilitates the floating action of the movable housing 430 in this direction.

In addition, in the present embodiment, the contoured portions 423 of the stationary housing 420 are secured with the top portions thereof to the movable housing 430. Accordingly, when the intermediate portions of the socket terminals 410 are resiliently deformed in the terminal array direction as the movable housing 430 floats in the terminal array direction, the thin strips 427 of the contoured portions 423 are resiliently deformed in the terminal array direction in concert with the intermediate portions. Accordingly, even if the movable housing 430 is in a floating state, the thin strips 427 of the contoured portions 423 keep covering the intermediate portions of the socket terminals 410. In addition, at such time, the predetermined clearance formed between the thin strips 427 and the intermediate portions is also maintained. As a result, a good characteristic impedance match can be assured in the socket terminals 410.

### Sixth Embodiment

Although in the first embodiment the overall shape of the intermediate portions 15 of the socket terminals 10 had a generally inverted L-shaped configuration, the shape of the intermediate portions is not limited thereto. In a sixth embodiment, sections curved in a generally S-shaped configuration are present in part of the intermediate portions of the socket terminals and, in this respect, the configuration is different from the first embodiment. In the present embodiment, the emphasis is on differences from the first embodiment, and sections identical to the first embodiment are assigned reference numerals obtained by adding “500” to the reference numerals used in the first embodiment and further discussion thereof is omitted.

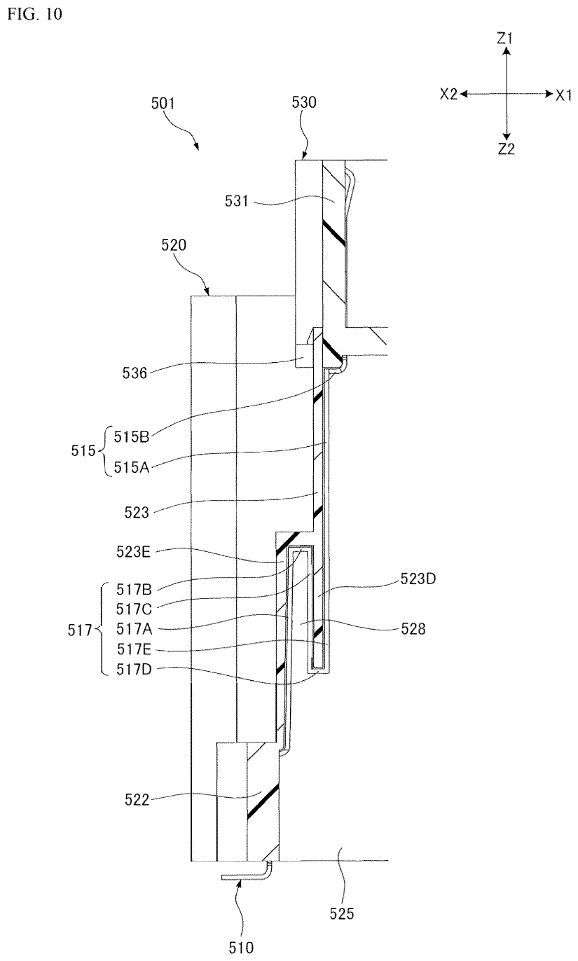

FIG. 10 is a cross-sectional view illustrating a cross-section of a socket connector 501 according to the sixth embodiment of the present invention taken in a plane perpendicular to the terminal array direction. In FIG. 10, the illustration of the half on the X1 side in the connector width direction is omitted. As shown in FIG. 10, in the present embodiment, the first leg portions 515A of the intermediate portions 515 of the socket terminals 510, in the bottom portions thereof, have resiliently deformable curved resilient portions 517 bent in a generally horizontal S-shaped configuration. The curved resilient portions 517 have an exterior leg portion 517A, an intermediate leg portion 517C, and an interior leg portion 517E extending in the up-down direction as well as an upper bend portion 517B and a lower bend portion 517D, each of which couples two of these leg portions.

Specifically, in an order from the outside in the connector width direction, there are provided, side by side, the exterior leg portion 517A, the intermediate leg portion 517C, and the interior leg portion 517E, with the top ends of the exterior leg portion 517A and the intermediate leg portion 517C coupled by the upper bend portion 517B and the bottom ends of the intermediate leg portion 517C and the interior leg portion 517E coupled by the lower bend portion 517D. In the present embodiment, providing a curved resilient portion 517 in part of the first leg portion 515A in this manner makes it possible to ensure a greater spring length for the first leg portion 515A without increasing the dimensions of the first leg portion 515A in the up-down direction.

In addition, as shown in FIG. 10, the contoured portions 523 provided as part of the stationary housing 520 have their top end portions rigidly retained in the bottom portion of the movable housing 530. Specifically, ledge portions 536 protruding in the connector width direction from the bottom end portions of the long walls 531 are formed in the movable housing 530, and the top end portions of the contoured portions 523 are retained by the ledge portions 536 using, for example, integral molding. As shown in FIG. 10, the contoured portions 523 have a projecting portion 523D projecting downwardly to a location directly above the lower bend portion 517D between the intermediate leg portion 517C and interior leg portion 517E. The projecting portion 523D is positioned spaced by a clearance of predetermined dimensions from the intermediate leg portion 517C, lower bend portion 517D, and interior leg portion 517E. This clearance is dimensioned to assure appropriate impedance in the socket terminals 510. Here, the value of the “appropriate impedance” is set within a predetermined allowable range and, accordingly, the aforementioned dimensions are set within a predetermined allowable range.

The projecting portion 523D, which is formed in part of the resiliently deformable contoured portion 523, is adapted to be capable of displacement in the connector width direction along with a generally U-shaped section formed by the intermediate leg portion 517C, lower bend portion 517D, and interior leg portion 517E. When the aforementioned generally U-shaped section is resiliently deformed, the projecting portion 523D is displaced in concert with said generally U-shaped section. As a result, even in the resiliently deformed state of the generally U-shaped section, a clearance dimensioned within the aforementioned allowable range is assured between the generally U-shaped section and the projecting portion 523D.

In addition, as shown in FIG. 10, a downwardly open recessed portion 528 is formed between the projecting portion 523D and another portion of the contoured portion 523, specifically section 523E, which is positioned outwardly of the projecting portion 523D in the connector width direction and is positioned within the same range as the projecting portion 523D in the up-down direction. The recessed portion 528 accommodates a generally inverted U-shaped section formed by the exterior leg portion 517A, upper bend portion 517B, and intermediate leg portion 517C. This generally inverted U-shaped section is spaced by a clearance of predetermined dimensions from the interior wall surfaces of the recessed portion 528. This clearance is dimensioned to assure appropriate impedance in the socket terminals 510. Here, the value of the “appropriate impedance” is set within a predetermined allowable range and, accordingly, the aforementioned dimensions are set within a predetermined allowable range.

Even in the resiliently deformed state of the aforementioned generally inverted U-shaped section, the clearance dimensioned within the aforementioned allowable range is assured between said generally inverted U-shaped section and the interior wall surfaces of the recessed portion 528.

In addition, in the present embodiment, as shown in FIG. 10, the second leg portions 515B of the socket terminals 510 are shorter than the second leg portions 15B of the first embodiment (see FIG. 3).

Although in the present embodiment the top end portions of the contoured portions 523 are retained by the ledge portions 536 of the movable housing 330 and, therefore, the contoured portions 523 and, by extension, the movable housing 530 do not move in the terminal array direction, as a substitute variation, the movable housing may be enabled to move in the terminal array direction. Specifically, engaging portions of the same shape as the engaging portions 23A of the first embodiment may be provided in the top end portions of the contoured portions 523 and, instead of the ledge portions 536, engageable portions of the same shape as the engageable portions 32A of the first embodiment may be provided in the bottom portion of the movable housing 530.

### Seventh Embodiment

Although in the first embodiment the socket connector 1 was matingly connected to the plug connector 2, i.e., the counterpart connector, such that the direction of connection was a direction perpendicular to the mounting face of the circuit board to which said socket connector 1 was mounted, in the seventh embodiment, it is adapted to be matingly connected to a plug connector, i.e., a counterpart connector, such that the direction of connection is a direction parallel to the mounting face of the circuit board, and, in this respect, the configuration is different from the first embodiment. In the present embodiment, the emphasis is on differences from the first embodiment, and sections identical to the first embodiment are assigned reference numerals obtained by adding “600” to the reference numerals used in the first embodiment and further discussion thereof is omitted.

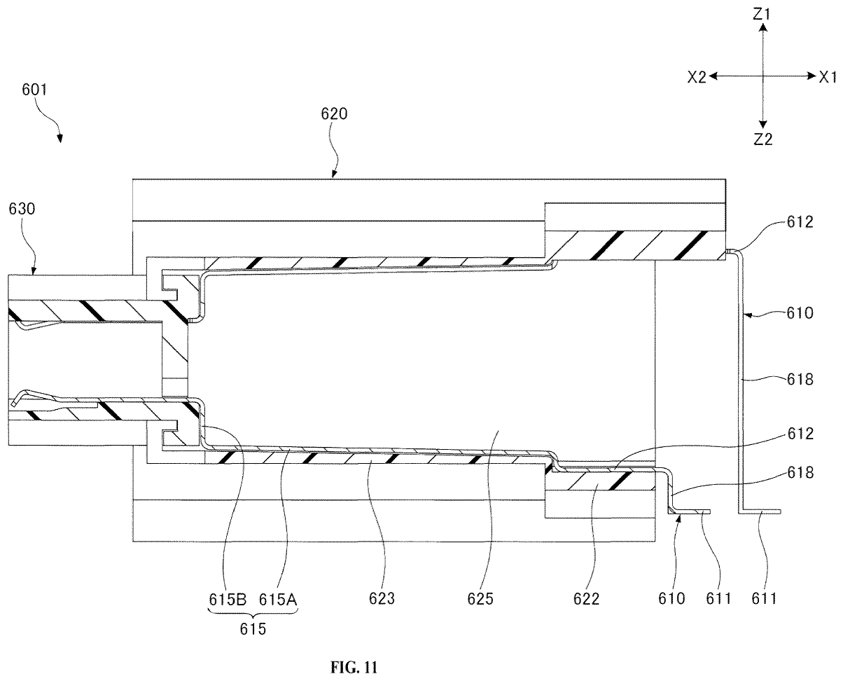

FIG. 11 is a cross-sectional view illustrating a cross-section of a socket connector 601 according to the seventh embodiment of the present invention taken in a plane perpendicular to the terminal array direction. FIG. 11 illustrates a cross-section taken at the location of socket terminals 610 in the terminal array direction (Y-axis direction). As shown in FIG. 11, in the present embodiment, the socket connector 601 is adapted to be matingly connected to a plug connector (not shown), i.e., a counterpart connector, such that the direction of connection is a left-to-right direction (X-axis direction in FIG. 11) parallel to the mounting face of the circuit board (not shown).

The socket connector 601 of the present embodiment is configured by laying the socket connector 1 of the first embodiment (see FIG. 3) on its side and extending one end section on the side where the connecting portions 11 are provided in the socket terminals 10. As shown in FIG. 11, in the present embodiment, extension portions 618, which are bent at the right ends (ends on the X1 side) of the stationary-side retained portions 612 and extend downwardly in a rectilinear manner, are provided in the socket terminals 610, and connecting portions 611 are provided extending to the right from the bottom ends of the extension portions 618. As shown in FIG. 11, the extension portion 618 of the upper (Z1-side) socket terminal 610 is positioned to the right (on the X1 side) of the extension portion 618 of the lower (Z2-side) socket terminal 610 and has a greater length than said extension portion 618.

In the socket connector 601 of the present embodiment, in the same manner as in the first embodiment, the clearance between the contoured portions 623 of the stationary housing 620 and the first leg portions 615A of the socket terminals 610 is dimensioned to assure appropriate impedance in the socket terminals 610. The clearance formed between the contoured portions 623 and first leg portions 615A is maintained even when the movable housing 630 is in a floating state.

Although in the previously discussed first through seventh embodiments the intermediate portions of the terminals are accommodated in their entirety within the interior space formed in the stationary housing, as a substitute variation, the intermediate portions may be only partially accommodated therein. In addition, although in the first through seventh embodiments the intermediate portions of the terminals are accommodated in the interior space of the stationary housing, as a substitute variation, an interior space may be formed in the movable housing and the intermediate portions may be accommodated within such an interior space.

Although in the first through seventh embodiments the contoured portions of the dielectric member are resiliently deformed when following the intermediate portions of the socket terminals, it is not essential for the contoured portions to be resiliently deformed, and they may be adapted to be displaced without attendant resilient deformation.

### DESCRIPTION OF THE REFERENCE NUMERALS

1, 101, 201, 301, 401, 501, 601 Socket connector
10, 110, 210, 310, 410, 510, 610 Socket terminals
12, 612 Stationary-side retained portion
14 Movable-side retained portion
15, 515 Intermediate portion
20, 120, 220, 320, 420, 520, 620 Stationary housing
25 Interior space
30, 130, 230, 330, 430, 530, 630 Movable housing
23, 140, 237, 423, 523, 623 Contoured portion
323 Stationary-side contoured portion
337 Movable-side contoured portion

1. An electrical connector for circuit boards disposed on a mounting face of a circuit board,
said electrical connector having a plurality of terminals arranged such that the terminal array direction is a direction parallel to the mounting face, a stationary housing secured to the circuit board through the medium of the terminals, and a movable housing capable of relative movement with respect to the stationary housing, and
the terminals having a stationary-side retained portion retained in the stationary housing, a movable-side retained portion retained in the movable housing, and a resiliently deformable intermediate portion located between the stationary-side retained portion and the movable-side retained portion, and being provided spanning between the stationary housing and the movable housing, wherein:
the intermediate portions, at least in part, are located in the interior space of the electrical connector for circuit boards,
the electrical connector for circuit boards has contoured portions made of dielectric material which, relative to the intermediate portions, are positioned on the side opposite the interior space and extend along the intermediate portions while being spaced by a clearance from the intermediate portions, and
the contoured portions are capable of following the intermediate portions when the intermediate portions are resiliently deformed in the connector width direction perpendicular to the terminal array direction.

2. The electrical connector for circuit boards according to claim 1, wherein the contoured portions are formed as part of the stationary housing and are capable of lockingly engaging the movable housing in the connector width direction.

3. The electrical connector for circuit boards according to claim 1, wherein the contoured portions are formed separately from the stationary housing and the movable housing, and are capable of lockingly engaging the movable housing in the connector width direction while being retained in the stationary housing.

4. The electrical connector for circuit boards according to claim 2, wherein the contoured portions have no sections abutting the movable housing in the terminal array direction, and
the movable housing is capable of moving in the terminal array direction without interfering with the contoured portions.

5. The electrical connector for circuit boards according to claim 1, wherein the contoured portions are formed as part of the movable housing and are capable of lockingly engaging the stationary housing in the connector width direction.

6. The electrical connector for circuit boards according to claim 1, wherein the contoured portions are formed separately from the stationary housing and the movable housing, and are capable of lockingly engaging the stationary housing in the connector width direction while being retained in the movable housing.

7. The electrical connector for circuit boards according to claim 5, wherein the contoured portions have no sections abutting the stationary housing in the terminal array direction, and are capable of moving in the terminal array direction along with the movable housing without interfering with the stationary housing.
